(19) United States
(12) Patent Application Publication
(10) Pub. No.: US 2020/0084098 A1
(43) Pub. Date: Mar. 12, 2020

(54) Techniques and Architectures for Managing Configuration of Network Devices

(71) Applicant: salesforce.com, inc., San Francisco, CA (US)

(72) Inventors: Chi Wang, Redmond, WA (US); Edet Nkposong, San Francisco, CA (US)

(21) Appl. No.: 16/125,570

(22) Filed: Sep. 7, 2018

(51) Int. Cl. H04L 12/24; H04L 29/08

(52) U.S. Cl. CPC H04L 41/0806; H04L 67/34; H04L 41/0246; H04L 41/0886

(57) ABSTRACT

Managing configuration of network devices. A configuration agent determines if a physical connection configured to transfer a configuration file is available. The configuration file is sent to the remote network device via the physical connection configured to transfer the configuration file, if available. The configuration agent determines if a serial connection to the remote network device is available. A sequence of text strings is sent automatically and without user interaction to the remote network device via the serial connection. The sequence of text strings is functionally equivalent to the configuration file. The sequence of text strings is caused to be appended to recreate the configuration file automatically and without user interaction. The remote network device is caused to apply the configuration file to configure the remote network device.

### TECHNICAL FIELD

Embodiments relate to techniques for configuring network devices. More particularly, embodiments relate to techniques for more efficiently and accurately configuring network devices by selecting from multiple available configuration paths.

### BACKGROUND

In busy modern datacenters thousands of servers can be added in a week to support growth of cloud-based business. These servers are supported by other network devices to provide the necessary infrastructure for the servers. Thus, configuring network devices including, for example, servers can be a mission critical task for the success of these cloud-based businesses.

Traditional techniques for configuring network devices remotely is through execution of a set of commands to set up an ethernet over serial connection over which a configuration file can be transmitted via, for example, secure copy (SCP). The configuration file can be applied to configure the target network device. Sending commands via serial connection to configure a device is a backup technique when TCP/IP (or similar) is not available. When having a large number of commands to apply (e.g., 400 or more), this process can be time consuming and error prone.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is one embodiment a networked environment (e.g., datacenter) in which one or more devices can be configured.

FIG. 2 is one embodiment a networked environment (e.g., datacenter) in which one or more devices can be configured utilizing a virtual SCP (or similar architecture).

FIG. 3 is a flow diagram of one embodiment of a technique to configure one or more devices utilizing a virtual SCP (or similar architecture).

FIG. 4 is a block diagram of one embodiment of a configuration agent.

FIG. 5 illustrates a block diagram of an environment wherein an on-demand database service might be used.

FIG. 6 illustrates a block diagram of an environment wherein an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

In various techniques described herein, a “Virtual SCP” can be provided that can operate to take a set of configuration commands, convert those commands to a configuration file and determine the most efficient route to the target networked device. In various embodiments, a virtual SCP agent can have some knowledge of a network topology as part of the process of determining the most efficient route to the target networked device.

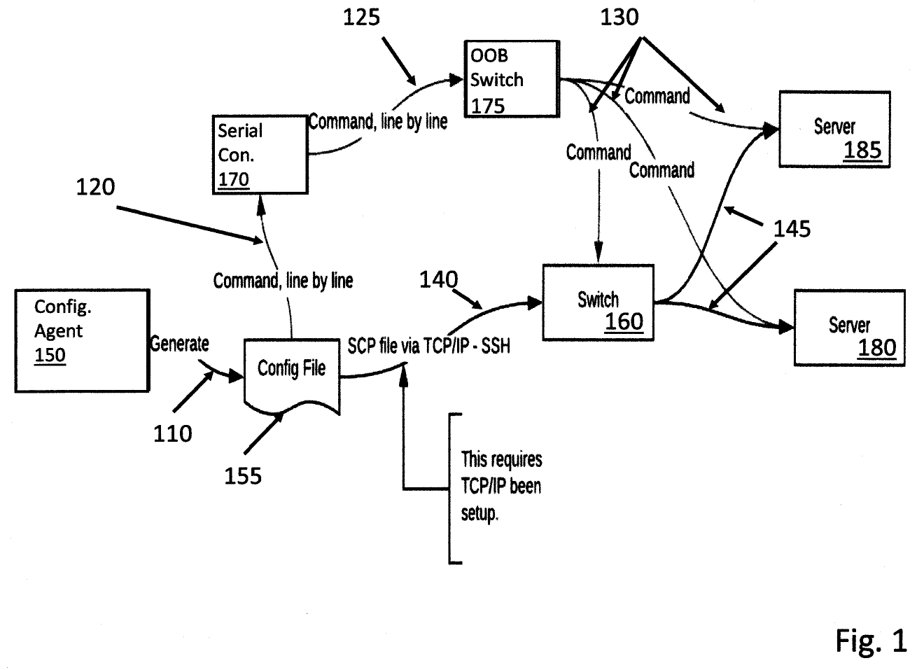

FIG. 1 is one embodiment a networked environment (e.g., datacenter) in which one or more devices can be configured. In a typical datacenter, two types of connections are utilized. Serial connections (110, 120, 125, 130 in FIG. 1), which are generally slow and lower bandwidth, and ethernet connections (140, 145 in FIG. 1), which are generally fast and higher bandwidth. Other types of connections can also be supported. Conceptually, there are typically two or more classes of connections, each having their own speed and bandwidth characteristics. The examples provided herein are based on serial (e.g., 110) and ethernet (e.g., 140); however, different specific protocols as well as more than two classes can be supported utilizing the techniques and strategies described herein.

In the architecture of FIG. 1, configuration agent 150 can function to generate (120) configuration file 155, which can contain any number of commands to be used to configure the target device. In environments like data centers a large number of devices (e.g., switches, servers, firewalls) can be configured identically over an extended period of time. Thus, individual configurations can be time consuming and complex.

Configuration file 155 can be sent to switch 160 to cause switch 160 to be configured according to the specifications of configuration file 155. In one embodiment, configuration file 155 is sent to switch 160 over a physical connection utilizing a transport protocol, for example TCP/IP. Configuration file 155 can be sent, for example as a SCP file; however, other file types and/or transport protocols can also be supported.

In various embodiments, switch 160 can send configuration file 155 (or a copy of configuration file 155) to additional network devices, for example, server 180 and/or server 185. This can be accomplished over physical connections 145 in a manner similar to the process of switch 160 receiving configuration file 155. Configuration of one or more network devices (e.g., 180, 185) based on sending configuration file 155 is more efficient and reliable than the alternative, command-based technique, discussed in greater detail below.

In various embodiments, commands from configuration file 155 can be sent to serial concentrator 170 via, for example, a serial connection. In one various embodiments, serial concentrator 170 forwards commands (e.g., line-by-line) to out of band (OoB) switch 175 over connection 125, which can be, for a serial type connection (or any other type of connection that does not support full file transfer). In various embodiments, OoB switch 175 can send commands to one or more network devices (e.g., 180, 185) via corresponding connections (e.g., 130).

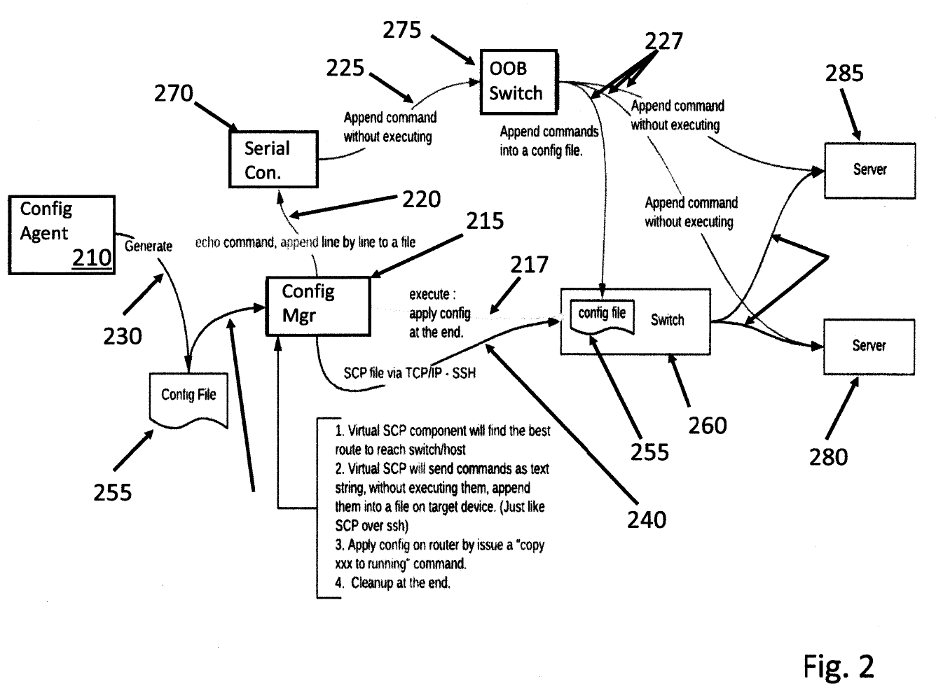

FIG. 2 is one embodiment a networked environment (e.g., datacenter) in which one or more devices can be configured utilizing a virtual SCP (or similar architecture). The examples provided herein are based on serial (e.g., 230) and ethernet (e.g., 240); however, different specific protocols as well as more than two classes can be supported utilizing the techniques and strategies described herein.

In the architecture of FIG. 2, configuration agent 210 can function to generate configuration file 255, which can contain any number of commands to be used to configure the target device. Configuration file 255 can be sent to configuration manager 215 to cause switch 260 to be configured according to the specifications of configuration file 255. As discussed in greater detail below, configuration manager 215 utilizes a novel and efficient technique to cause switch 260 to be configured in accordance with the parameters of configuration file 255.

As described in greater detail below, configuration manager 215 can function to determine a best route for configuration file 255 between configuration manager 215 and the device to be configured (e.g., switch 260). The example of FIG. 2 illustrates two routes (240/217 and 220); however, more than two possible routes can be managed using the techniques described herein. In one embodiment, if available, configuration manager sends configuration file 255 via high-speed (e.g., ethernet) connection 240 and switch 260 stores configuration file 255 in its own memory.

Configuration manager 215 can subsequently cause (217) switch 260 to execute/apply configuration file 255 to cause switch 260 to be configured according to the parameters of configuration file 255. This process can be replicated from switch 260 to other network devices (e.g., server 280, server 285).

In one embodiment, if the high-speed connection (e.g., 240) is not available, configuration manager 215 can cause the configuration commands corresponding to configuration file 255 to be sent (e.g., utilizing ECHO commands) to serial concentrator 270 via low-speed (e.g., serial connection) 220. In one embodiment, serial concentrator 270 can append the commands to recreate configuration file 255. This process can be continued from serial concentrator 270 over connection 225 to out of band (OoB) switch 275 to switch 260 where configuration file 255 can be recreated and executed/applied. OoB switch can further send configuration file 255 in the same manner to additional network devices (e.g., 280, 285) over connection 227. In one embodiment, cleanup operations can be performed, for example, deleting configuration file 255 and any temporary files created during configuration.

In various embodiments, configuration manager 215 can automatically manage configuration of multiple network devices based on available connections, network topology, device type and/or other factors. In one embodiment, configuration agent 210 can be used to generate configuration file 255, which can be provided to configuration manager 215. Thus, configuration of multiple network devices can be achieved more efficiently and more accurately utilizing the techniques described herein.

One advantage is that configuration agent 210 (or other component) can provide a generic configuration interface so that the entity configuring the network devices is not required to select a solution based on which type of connection is available. Further, that entity is not required to manually/sequentially provide configuration information based on connection type available.

In one embodiment, configuration manager 215 can utilize the following (or similar) application program interface (API):

//ApplyConfiguration applies config to targetDevice.
//
//targetDevice is the target device to config.
//secrets is list of credentials used to access devices in the potential paths.
//config is the configuration to apply
//
//Returns error if any.
ApplyConfiguration(targetDevice Device, secrets SecretProvider,
config File) (error)

The following is a sample segment of a network configuration file:

policy-map type network-qos jumbo
class type network-qos class-default
mtu 9216
!
system qos
service-policy type network-qos jumbo
!
!
copp profile lenient
!
bfd interval 400 min_rx 400 multiplier 3
!
ip dhcp relay information option
ip dhcp relay sub-option circuit-id format-type string

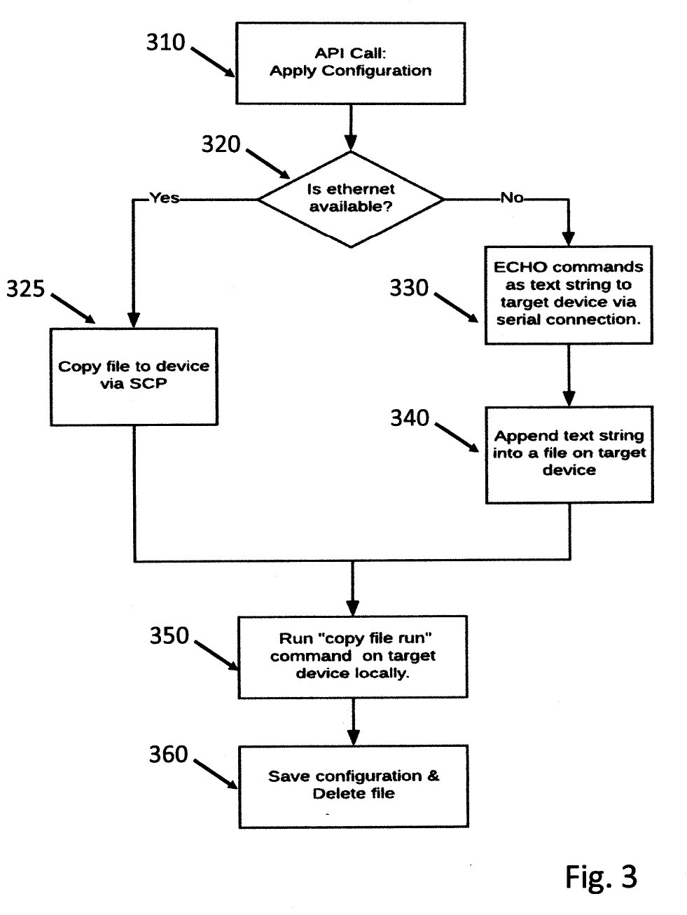

FIG. 3 is a flow diagram of one embodiment of a technique to configure one or more devices utilizing a virtual SCP (or similar architecture). The example of FIG. 3 is based on a simple use case utilizing an architecture similar to FIG. 2.

In one embodiment, a configuration agent (or other component) can be used to utilize initiate the configuration process, 310. As described above, this (or a similar) API call can be used to imitate configuration of one or more network devices generically without specifying what type of connection is to be used or what type of configuration delivery (e.g., configuration file, command-by-command) is to be used.

If a high-speed connection (e.g., ethernet) is available, 320, the configuration file is copied to the target device (e.g., via SCP), 325. If a high-speed connection is not available, 320, commands are copied (e.g., via ECHO command) as text strings to the target device via the low-speed (serial) connection, 330. One or more text strings are appended into a file on the target device, 340.

In one embodiment, when the target device has the configuration file, whether via the high-speed connection or the low-speed connection, the configuration file can be executed/applied by the target device, 350. The configuration data can be saved and the configuration file can be deleted, 360. In other embodiments, different cleanup can be accomplished.

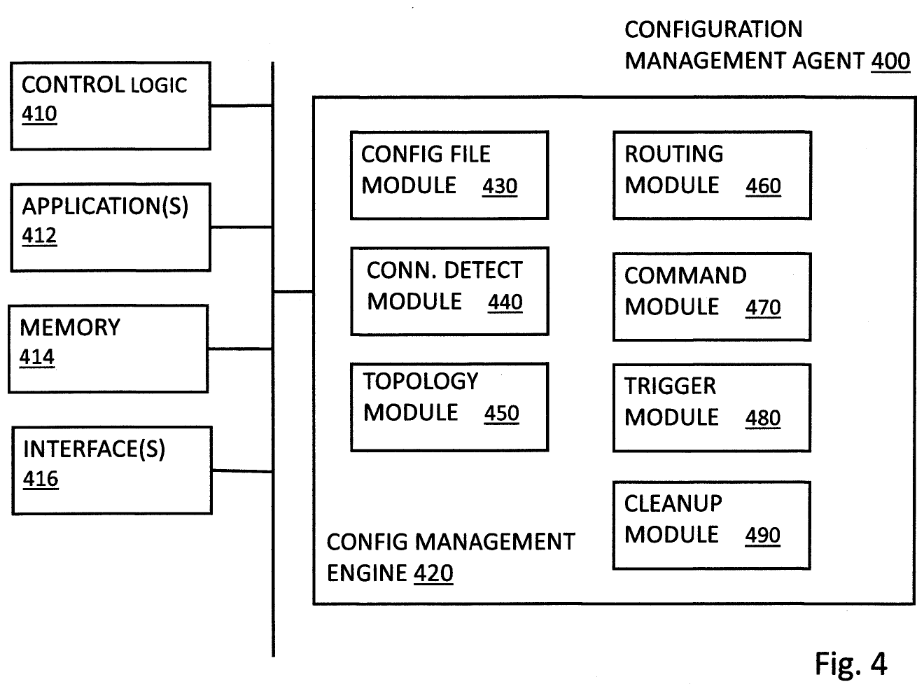

FIG. 4 is a block diagram of one embodiment of a configuration management agent. In one embodiment, one or more configuration agents may exist and/or operate within the host environment. The agent of FIG. 4 may provide configuration management functionality as described, for example, with respect to FIGS. 2 and 3. The agent of FIG. 4 may also provide additional functionality.

In one embodiment, configuration management agent 400 includes control logic 410, which implements logical functional control to direct operation of configuration management agent 400, and/or hardware associated with directing operation of configuration management agent 400. Logic may be hardware logic circuits and/or software routines. In one embodiment, configuration management agent 400 includes one or more applications 412, which represent a code sequence and/or programs that provide instructions to control logic 410.

Configuration management agent 400 includes memory 414, which represents a memory device and/or access to a memory resource for storing data and/or instructions. Memory 414 may include memory local to configuration management agent 400, as well as, or alternatively, including memory of the host system on which configuration management agent 400 resides. Configuration management agent 400 also includes one or more interfaces 416, which represent access interfaces to/from (an input/output interface) configuration management agent 400 with regard to entities (electronic or human) external to configuration management agent 400.

Configuration management agent 400 also includes configuration management engine 420, which represents one or more functions or module that enable configuration management agent 400 to provide the index backups as described above. The example of FIG. 4 provides several modules that may be included in configuration management engine 420; however, different and/or additional modules may also be included. Example modules that may be involved in providing the configuration management functionality include user configuration file module 430, connection detection module 440, topology module 450, routing module 460, command module 470, trigger module 480, cleanup module 490. Each of these modules may further include other sub-modules to provide other functions. As used herein, a module refers to routine, a subsystem, logic circuit, microcode, etc., whether implemented in hardware, software, firmware or some combination thereof.

Configuration file module 430 operates to receive, store and/or distribute configuration files as discussed above. In one embodiment, configuration file module 430 can be utilized to generate and/or edit configuration files. Configuration file module 430 can interact with one or more of the other modules of configuration management engine 420 to provide the functionality described herein.

Connection detection module 440 operates to detect and/or monitor connections between one or more network devices. For example, connection detection module 440 can detect whether a high-speed connection is available between configuration management agent 400 and a target network device. Similarly, connection detection module 440 can detect whether a low-speed connection is available between configuration management agent 400 and a target network device. This information can be periodically and dynamically updated to adapt to changing network conditions. Connection detection module 440 can interact with one or more of the other modules of configuration management engine 420 to provide the functionality described herein.

Topology module 450 operates to monitor network topology of some or all of the network in which configuration management agent 400 operates. In one embodiment, topology module 450 interacts with one or more connection detection modules (e.g., 440) to determine what type of connections are available between various network devices. Topology module 450 can also maintain topology information in its own memory and/or in external memory (e.g., memory 414). Topology module 450 can interact with one or more of the other modules of configuration management engine 420 to provide the functionality described herein.

Routing module 460 operates to determine a most efficient and/or most reliable route for the configuration file to travel to the target device. Utilizing connection information and/or topology information routing module 460 can determine the route to be used to deliver the configuration module. Thus, in various embodiments, routing module 460 interacts with connection detection module 440, topology module 450 and/or other modules to determine the route to utilize.

Command module 470 operates to manage and/or transmit commands to accomplish network device configuration as specified by the configuration module. For example, command module 470 can operate to send a sequence of commands to another network device that will gather and append the commands to accomplish the desired configuration operations. Command module 470 can interact with one or more of the other modules of configuration management engine 420 to provide the functionality described herein.

Trigger module 480 operates to cause one or more network devices to implement the configuration specifications of the configuration file(s). In one embodiment, after the target network device has received and appended (if necessary) the components of the configuration file, trigger module 480 can cause the recipient network device to implement the corresponding configuration operations. Trigger module 480 can interact with one or more of the other modules of configuration management engine 420 to provide the functionality described herein.

Cleanup module 490 operates to cause one or more target network devices to perform cleanup operations after the configuration has completed. In one embodiment, cleanup module 490 causes the configuration file(s) to be deleted from the target network device. Cleanup module 490 can interact with one or more of the other modules of configuration management engine 420 to provide the functionality described herein.

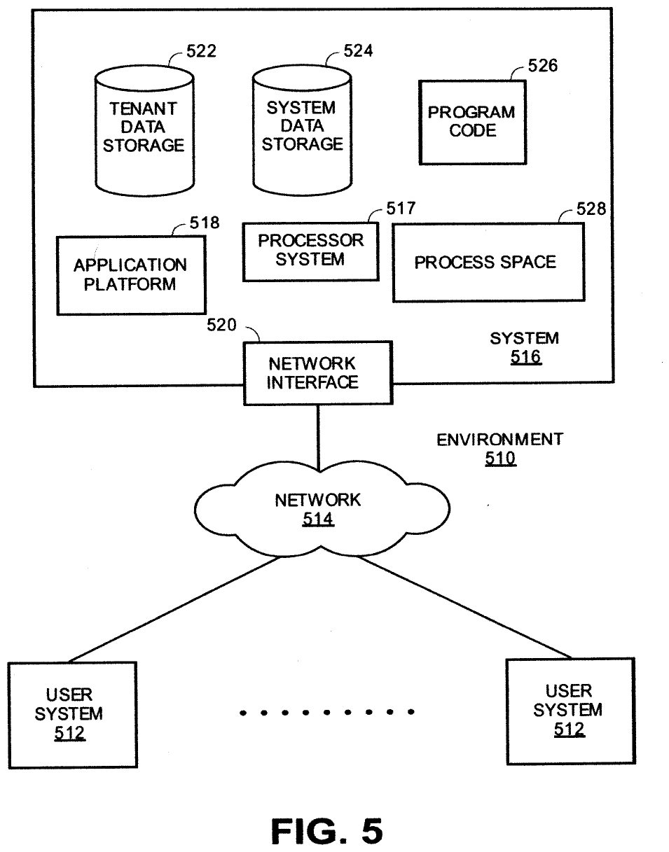

FIG. 5 illustrates a block diagram of an environment 510 wherein an on-demand database service might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

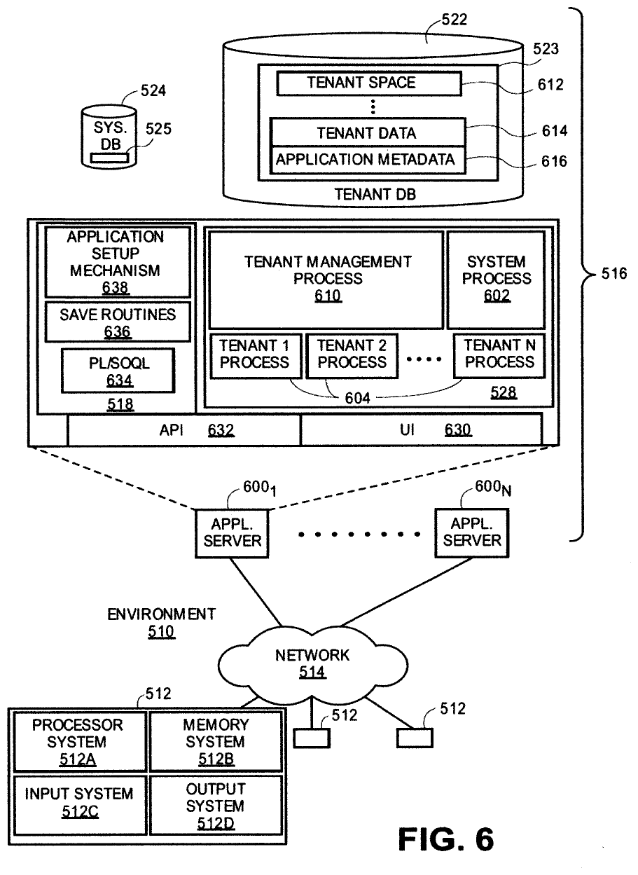

Environment 510 is an environment in which an on-demand database service exists. User system 512 may be any machine or system that is used by a user to access a database user system. For example, any of user systems 512 can be a handheld computing device, a mobile phone, a laptop computer, a work station, and/or a network of computing devices. As illustrated in herein FIG. 5 (and in more detail in FIG. 6) user systems 512 might interact via a network 514 with an on-demand database service, which is system 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Core series processor or the like. Similarly, system 516 (and additional instances of an MTS, where more than one is present) and all of their components might be operator configurable using application(s) including computer code to run using a central processing unit such as processor system 517, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 BIG-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon instructions that, when executed by one or more processors, are configurable to cause the one or more processors to cause at least one remote network device to be configured, the one or more processors to:
determine, automatically and without user interaction with the one or more processors, if a physical connection configured to transfer a configuration file is available;
send the configuration file, automatically and without user interaction with the one or more processors, to the remote network device via the physical connection configured to transfer the configuration file, if available;
determine, automatically and without user interaction with the one or more processors, if a serial connection to the remote network device is available;
send a sequence of text strings, automatically and without user interaction with the one or more processors, to the remote network device via the serial connection, wherein the sequence of text strings is functionally equivalent to the configuration file, wherein the sequence of text strings is caused to be appended to recreate the configuration file automatically and without user interaction with the one or more processors and the remote network device is caused to apply the configuration file to configure the remote network device.

2. The non-transitory computer-readable medium of claim 1 wherein the physical connection configured to transfer the configuration file comprises a direct Ethernet connection to a remote network device to be configured.

3. The non-transitory computer-readable medium of claim 2 wherein the configuration file is transmitted over the direct Ethernet connection utilizing a TCP/IP protocol.

4. The non-transitory computer-readable medium of claim 1 wherein the sequence of text strings is to be received and appended by an intermediate network device between a device sending the sequence of text strings and the remote network device to be configured.

5. The non-transitory computer-readable medium of claim 4 wherein the intermediate network device sends the appended sequence of text strings to multiple network devices.

6. The non-transitory computer-readable medium of claim 1 further comprising causing the remote network device clean up the configuration file.

7. The non-transitory computer-readable medium of claim 1 wherein the serial connection utilizes a virtual secure copy (SCP) command agent.

8. A method to cause at least one remote network device to be configured, the method comprising:
determining if a physical connection configured to transfer a configuration file is available;
sending the configuration file to the remote network device via the physical connection configured to transfer the configuration file, if available;
determining if a serial connection to the remote network device is available;
sending a sequence of text strings, automatically and without user interaction with the one or more processors, to the remote network device via the serial connection, wherein the sequence of text strings is functionally equivalent to the configuration file, wherein the sequence of text strings is caused to be appended to recreate the configuration file automatically and without user interaction with the one or more processors and the remote network device is caused to apply the configuration file to configure the remote network device.

9. The method of claim 8 wherein the physical connection configured to transfer the configuration file comprises a direct Ethernet connection to a remote network device to be configured.

10. The method of claim 9 wherein the configuration file is transmitted over the direct Ethernet connection utilizing a TCP/IP protocol.

11. The method of claim 8 wherein the sequence of text strings is to be received and appended by an intermediate network device between a device sending the sequence of text strings and the remote network device to be configured.

12. The method of claim 11 wherein the intermediate network device sends the appended sequence of text strings to multiple network devices.

13. The method of claim 8 further comprising causing the remote network device clean up the configuration file.

14. The method of claim 8 wherein the serial connection utilizes a virtual secure copy (SCP) command agent.

15. A system comprising:
a physical memory structure;
one or more network devices interconnected with each other and with the physical memory structure, each of the network devices having at least one memory device and at least one hardware processor, the one or more network devices configurable to determine if a physical connection configured to transfer a configuration file is available, to send the configuration file to the remote network device via the physical connection configured to transfer the configuration file, if available, to determine if a serial connection to the remote network device is available, to send a sequence of text strings, automatically and without user interaction with the one or more processors, to the remote network device via the serial connection, wherein the sequence of text strings is functionally equivalent to the configuration file, wherein the sequence of text strings is caused to be appended to recreate the configuration file automatically and without user interaction with the one or more processors and the remote network device is caused to apply the configuration file to configure the remote network device.

16. The system of claim 15 wherein the physical connection configured to transfer the configuration file comprises a direct Ethernet connection to a remote network device to be configured.

17. The system of claim 16 wherein the configuration file is transmitted over the direct Ethernet connection utilizing a TCP/IP protocol.

18. The system of claim 15 wherein the sequence of text strings is to be received and appended by an intermediate network device between a device sending the sequence of text strings and the remote network device to be configured.

19. The system of claim 18 wherein the intermediate network device sends the appended sequence of text strings to multiple network devices.

20. The non-transitory computer-readable medium of claim 15 further comprising causing the remote network device clean up the configuration file.

21. The non-transitory computer-readable medium of claim 15 wherein the serial connection utilizes a virtual secure copy (SCP) command agent.
